(19) United States
(12) Patent Application Publication
(10) Pub. No.: US 2020/0020234 A1
(43) Pub. Date: Jan. 16, 2020

(54) SAFETY TECHNOLOGIES FOR CONNECTED AUTOMATED VEHICLE HIGHWAY SYSTEMS

(71) Applicant: CAVH LLC, Fitchburg, WI (US)

(72) Inventors: Yang Cheng, Middleton, WI (US); Bin Ran, Fitchburg, WI (US); Shen Li, Madison, WI (US); Zhen Zhang, Madison, WI (US); Shuoxuan Dong, Madison, WI (US); Tianyi Chen, Madison, WI (US); Linhui Ye, Madison, WI (US); Kunsong Shi, Madison, WI (US); Xiaotian Li, Madison, WI (US); Huachun Tan, Madison, WI (US); Jian Zhang, Fitchburg, WI (US)

(21) Appl. No.: 16/504,977

(22) Filed: Jul. 8, 2019

Related U.S. Application Data
(60) Provisional application No. 62/695,938, filed on Jul. 10, 2018.

(51) Int. Cl. G08G 1/16; G08G 1/01; G08B 25/00; B60W 50/14; B60W 40/105; G05D 1/02; G05D 1/00

(52) U.S. Cl. CPC G08G 1/164; G08G 1/166; G08G 1/0133; G08B 25/00; H04L 67/10; B60W 40/105; G05D 1/0291; G05D 1/0027; B60W 50/14

(57) ABSTRACT

The present technology relates generally to systems and methods for safe vehicle operations and control of connected automated vehicle highway (CAVH) systems to operate and manage connected and automated vehicles.

This application claims priority to U.S. provisional patent application Ser. No. 62/695,938, filed Jul. 10, 2018, which is incorporated herein by reference in its entirety.

### FIELD

The present technology relates generally to systems and methods for safe vehicle operations and control of connected automated vehicle highway (CAVH) systems to operate and manage connected and automated vehicles.

### BACKGROUND

Vehicles that are capable of sensing their environment and navigating without or with reduced human input (“autonomous vehicles”) are in development. At present, they are in experimental testing and not in widespread commercial use. Existing approaches for operating, managing, and controlling autonomous vehicles require expensive and complicated on-board systems, making widespread implementation a substantial challenge.

### SUMMARY

The present technology relates generally to systems and methods for providing safe vehicle operations and control, e.g., for connected and automated vehicle highway (CAVH) systems. In some embodiments, safety technologies include proactive measures (e.g., preventive measures based on incident prediction and risk index estimation, deployed to before actual incident occurs), active measures (e.g., measures for imminent incidents, deployed before harms occur, based on rapid incident detection), and passive measures (e.g., post-incident measures to alleviate further harms and losses, based on individual roadside unit (RSU), vehicles, and collaboration and coordination of multiple CAVH entities).

In some embodiments, the technology provided herein relates to CAVH systems configured to send detailed and time-sensitive control instructions to individual vehicles for, e.g., vehicle following, lane changing, route guidance, and related information. In some embodiments, the technology comprises a connected automated vehicle highway system and methods and/or components thereof as described in U.S. patent application Ser. No. 15/628,331, filed Jun. 20, 2017 and U.S. Provisional Patent Application Ser. Nos. 62/626,862, filed Feb. 6, 2018, 62/627,005, filed Feb. 6, 2018, 62/655,651, filed Apr. 10, 2018, and 62/669,215, filed May 9, 2018, the disclosures of which are herein incorporated by reference in their entireties (referred to herein as a CAVH system). In some embodiments, the technology relates to the use of a connected automated vehicle highway system and methods and/or components thereof for heavy and special vehicles, e.g., as described in U.S. Provisional Patent Application Ser. No. 62/687,435, filed Jun. 20, 2018, which is incorporated herein by reference.

Accordingly, provided herein are embodiments of a technology related to a safety system to provide and/or improve safety to an operations and control component of a connected and automated vehicle highway (CAVH) system. In some embodiments, the safety system in configured to provide a transportation entity with information and control instructions. In some embodiments, information and control instructions enhance safety of the CAVH system at a microscopic, mesoscopic, and/or macroscopic level. In some embodiments, a transportation entity is selected from the group consisting of a motorized vehicle, a non-motorized vehicle, and a pedestrian. In some embodiments, the safety system further comprises one or more of: a roadside unit (RSU) network; a Traffic Control Unit (TCU) and Traffic Control Center (TCC) network; one or more Vehicle onboard units (OBU) and vehicle interfaces; a traffic operations center (TOC); and/or a cloud-based platform (e.g., “CAVH cloud”) configured to provide, support, and/or manage information and computing services, e.g., as described in U.S. Provisional Patent Application Ser. No. 62/691,391, incorporated herein by reference in its entirety.

In some embodiments, the safety system is configured to perform proactive methods comprising predicting traffic incidents, estimating risk index, and managing vehicles to minimize and/or eliminate a future chance of traffic incidents. In some embodiments, the safety system is configured to perform active methods comprising detecting traffic incidents and minimizing and/or eliminating a future chance of harm. In some embodiments, the safety system is configured to perform passive methods post-incident comprising minimizing further harms and losses. In some embodiments, the safety system is configured to perform a method comprising sensing, predicting transportation behavior, planning and making decisions, controlling a vehicle, and/or deploying a safety device.

As described herein, in some embodiments the safety system is configured to perform a method at a microscopic level. For instance, in some embodiments, the safety system comprises a method that is performed by an individual RSU, an individual vehicle, and/or an individual vehicle group (e.g., a platoon).

As described herein, in some embodiments the safety system is configured to perform a method at a mesoscopic (e.g., intermediate) level. For instance, in some embodiments, the safety system comprises a method that is performed by a RSU/TCU/TCC network or portion thereof.

As described herein, in some embodiments the safety system is configured to perform a method at a macroscopic level. For instance, in some embodiments, the safety system comprises a method that is performed by the CAVH system.

As used herein, the term “support” when used in reference to one or more components of the CAVH system providing support to and/or supporting one or more other components of the CAVH system refers to, e.g., exchange of information and/or data between components and/or levels of the CAVH system, sending and/or receiving instructions between components and/or levels of the CAVH system, and/or other interaction between components and/or levels of the CAVH system that provide functions such as information exchange, data transfer, messaging, and/or alerting.

In some embodiments, a method performed at the microscopic level comprises generating a safety strategy. In some embodiments, generating a safety strategy comprises identifying a safety issue by an RSU and determining a safety measure to deploy. In some embodiments, the method comprises supporting said RSU by communications with a TCU. In some embodiments, the method further comprises sending control instructions from an RSU to an OBU on a target vehicle. In some embodiments, a group of vehicles comprises said target vehicle. In some embodiments, the method further comprises deploying a safety measure. In some embodiments, deploying said safety measure comprises controlling the target vehicle using instructions provided by the OBU. In some embodiments, deploying said safety measure comprises sending information about vehicle status and/or the safety measures to an RSU. In some embodiments, deploying said safety measure comprises sending a safety request to an RSU.

In some embodiments, a method performed at the mesoscopic level comprises generating a safety strategy. In some embodiments, the method comprises coordinating communication between one or more RSU and upper TCC/TCU. In some embodiments, the method comprises supporting said RSU and/or TCC/TCU by the TOC. In some embodiments, the method comprises supporting said RSU and/or TCC/TCU by the CAVH Cloud. In some embodiments, the method comprises predicting mesoscopic safety events. In some embodiments, the method comprises detecting mesoscopic safety events. In some embodiments, generating a safety strategy comprises identifying a safety measure to deploy. In some embodiments, the method further comprises sending control instructions from an RSU to an OBU of a target vehicle. In some embodiments, a group of vehicles comprises said target vehicle.

In some embodiments, a method performed at a macroscopic level comprises generating a safety strategy. In some embodiments, a safety strategy comprises predicting and/or detecting macroscopic safety events. In some embodiments, predicting and/or detecting macroscopic safety events is performed by the whole or partial network of RSUs and/or TCC/TCU. In some embodiments, a method is supported by the TOC and/or the CAVH Cloud. In some embodiments, the safety strategy comprises determining a safety measure to be deployed. In some embodiments, the method further comprises sending control instructions and/or guidance information from an RSU to an OBU on a target vehicle. In some embodiments, a group of vehicles comprises said target vehicle. In some embodiments, the method performed at a microscopic level comprises calculating a safety driving range for vehicle control, identifying a safety issue, and/or determining a safety measure to be deployed. In some embodiments, the calculating, identifying, and/or determining is/are performed by an OBU. In some embodiments, the methods comprise supporting said OBU with control instructions provided by an RSU. In some embodiments, the method comprises deploying a safety measure by an OBU according to said safety strategy. In some embodiments, the method comprises reporting said safety measures and/or safety strategy to an RSU.

In some embodiments, the technology relates to a safety system configured to perform system based hot backup methods. In some embodiments, system based hot backup methods comprise sending vehicle backup data to an RSU. In some embodiments, system based hot backup methods comprise sending vehicle backup data to an RSU. In some embodiments, system based hot backup methods comprise sending vehicle backup data to an RSU in real-time. In some embodiments, system based hot backup methods comprise sending a signal from an RSU to a vehicle indicating that the RSU is ready to receive backup data. In some embodiments, system based hot backup methods comprise sending vehicle backup data to the CAVH cloud. In some embodiments, system based hot backup methods comprise sending backup data from an RSU, the TCC/TCU network, and/or the TOC to the CAVH cloud.

In some embodiments, the technology relates to a safety system comprising a roadside safety device. In some embodiments, the roadside safety device comprises a physical safety component. In some embodiments, the physical safety component is an impact absorbing component. In some embodiments, the impact absorbing component is an airbag. In some embodiments, the airbag is designed to inflate rapidly and deflate rapidly during a collision or impact. In some embodiments, the airbag comprises an airbag cushion, a flexible bag, an inflation module, and controller module. In some embodiments, the airbag is configured to cushion a vehicle during a crash. In some embodiments, the airbag is configured to minimize and/or eliminate passenger injuries. In some embodiments, the airbag is configured to minimize and/or eliminate vehicle loss and/or damage. In some embodiments, the airbag is configured to minimize and/or eliminate injury and/or damage of infrastructure impacted by the vehicle. In some embodiments, the airbag is configured to minimize and/or eliminate injury and/or damage of a vehicle impacted by the vehicle. In some embodiments, the airbag is configured to minimize and/or eliminate injury to persons impacted by the vehicle. In some embodiments, the technology comprises a proactive exterior airbag system and a related deployment method for a motor vehicle, e.g., as described in U.S. Pat. No. 5,732,785, incorporated herein by reference. In some embodiments, the roadside safety device comprises a logical safety component. In some embodiments, the logical safety component provides incident management services. In some embodiments, the roadside safety device comprises a component providing assistance stop a vehicle in an emergency. In some embodiments, the roadside safety device communicates with an RSU. In some embodiments, the RSU provides instructions to deploy and/or deploys said roadside safety device to implement a safety strategy. In some embodiments, the incident management services perform a method comprising identifying an incident and/or characterizing an incident. In some embodiments, the incident management services perform a method comprising locating an incident. In some embodiments, the incident management services perform a method comprising reporting an incident to first responders automatically.

In some embodiments, the technology provides a safety system configured to perform a method for a guided vehicle crash. In some embodiments, the method for a guided vehicle crash controls vehicle impact to minimize and/or eliminate impact or impact-caused injuries and loss. In some embodiments, the method comprises monitoring vehicles by an RSU and/or a network of RSU. In some embodiments, the monitoring is continuous. In some embodiments, the method comprises triggering a crash control measure when a control threshold is attained or exceeded. In some embodiments, the crash control measure comprises activating an impact absorbing component. In some embodiments, the impact absorbing component is activated by a signal sent from an RSU. In some embodiments, the crash control measure comprises sending updated control instructions to a vehicle and/or to a driver. In some embodiments, the crash control measure comprises sending data to TCU. In some embodiments, an RSU sends said data to said TCU. In some embodiments, the crash control measure comprises receiving instructions from a TCU. In some embodiments, an RSU receives said instructions. In some embodiments, the instructions are sent to an OBU to control a vehicle. In some embodiments, the crash control measure comprises sending warnings and/or updated vehicle control instructions to other vehicles and travelers.

In some embodiments, the technology relates to safety systems configured to perform a method for emergency vehicle braking. In some embodiments, the method comprises monitoring vehicles by an RSU and/or a network of RSU. In some embodiments, the monitoring is continuous. In some embodiments, the method comprises sending a warning message to a driver and/or a vehicle. In some embodiments, the warning message comprises instructions to a driver to assume control of a vehicle. In some embodiments, the warning message is sent when a control threshold is attained and/or exceeded. In some embodiments, an RSU sends said warning message. In some embodiments, an RSU sends control instructions to a vehicle when the vehicle driver does not assume control of the vehicle. In some embodiments, an RSU sends control instructions to a vehicle when the vehicle driver does not have sufficient response time to assume control of the vehicle. In some embodiments, the method comprises sending data from an RSU to an upper level TCU. In some embodiments, the method comprises receiving instructions at an RSU from a TCU. In some embodiments, the method comprises sending warnings and/or updated vehicle control instructions to other vehicles and travelers.

In some embodiments, the technology provides a safety system configured to control the speed of one or more vehicles (see, e.g., U.S. Pat. App. Pub. No. 2013/0297196, incorporated herein by reference). In some embodiments, the technology provides systems and methods for determining (e.g., calculating) a safe (e.g., target) speed. In some embodiments, the technology provides systems and methods for sending instructions to a vehicle to drive at a safe (e.g., target) speed. In some embodiments, the technology provides systems and methods for controlling a vehicle at a safe (e.g., target) speed. In some embodiments a safe and/or target speed minimizes acceleration and deceleration (e.g., to maximize efficiency). In some embodiments, the technology provides a vehicle comprising a component configured to perform driving assist methods based on the target speed.

In some embodiments, the technology relates to a safety system configured to perform a method for coordinating a plurality of vehicles in a platoon. In some embodiments, the method comprising adjusting driving speed a lead vehicle in a platoon. In some embodiments, the driving speed is adjusted according to a detected and/or predicted traffic incident and/or safety event. In some embodiments, the method comprises calculating the driving speed for platoon vehicles. In some embodiments, an RSU is configured to calculate the driving speed for platoon vehicles. In some embodiments, the method comprises supporting said RSU by upper level TCU/TCC.

In some embodiments, the technology relates to a safety system configured to perform a method for providing a pavement condition warning. In some embodiments, the method comprises detecting pavement conditions of roads. In some embodiments, an RSU or a network of RSU detect pavement conditions of roads. In some embodiments, the method comprises providing information and/or instructions to a vehicle. In some embodiments, an OBU is configured to control a vehicle on a road having a pavement condition using said information and/or instructions for driving on said road and said pavement condition.

In some embodiments, the technology relates to safety systems configured to perform a method for managing a traffic incident. In some embodiments, the method comprises detecting a traffic incident. In some embodiments, the method comprises informing an incident management agency of said traffic incident. In some embodiments, a RSU or a network of RSU detects a traffic incident and/or informs an incident management agency of said traffic incident.

In some embodiments, the technology is related to safety systems configured to perform a method for pedestrian/bicycle detection and warning. In some embodiments, the method comprises mapping pedestrians and/or bicycles. In some embodiments, the method comprises sending vehicle control instructions to a vehicle and/or a vehicle platoon to avoid a pedestrian/bicycle. In some embodiments, an RSU or a network of RSU provides map information describing a pedestrian/bicycle and/or sends vehicle control instructions to a vehicle and/or a vehicle platoon to avoid a pedestrian/bicycle.

In some embodiments, the technology is related to safety systems configured to perform a method for dynamic routing of emergency vehicles. In some embodiments, a method comprises sending control instructions from a TOC to an RSU or a plurality of RSU to provide a clear path for an emergency vehicle traveling to a traffic incident. In some embodiments, a method comprises forwarding an emergency vehicle request to an agency, wherein said request comprises instructions for dispatching an emergency vehicle to drive on clear path. In some embodiments, the forwarding step is performed by one or more of an RSU, TCC/TCU, and/or TOC.

In some embodiments, the technology is related to safety system configured to perform a method for managing a communication failure. In some embodiments, the method comprises detecting a communication error between one or more components of the system. In some embodiments, the method comprises transferring control of a vehicle to said vehicle and/or a driver. In some embodiments, an RSU transfers control of a vehicle to said vehicle and/or a driver. In some embodiments, the method comprises activating emergency stop methods for a vehicle if the vehicle and/or driver does not assume control of the vehicle. In some embodiments, the method comprises guiding a vehicle to a safe stop. In some embodiments, the method comprises guiding a vehicle to a safe stop at a sidewalk, emergency stop lane, or side of a road. In some embodiments, the emergency stop methods comprise guiding a vehicle to a safe stop at a sidewalk, emergency stop lane, or side of a road. In some embodiments, the method comprises sending a warning to the CAVH cloud. In some embodiments, the method comprises sending a warning to an RSU and/or a network of RSU. In some embodiments, the method comprises activating a backup communication channel. In some embodiments, the backup communication channel is used to establish communication with a vehicle.

In some embodiments, the technology provided herein is related to a safety system configured to perform a method for transferring control of a vehicle to a human. In some embodiments, the method comprises sending a warning to a system-controlled vehicle. In some embodiments, the method comprises requesting a human to assume control of a vehicle. In some embodiments, the method comprises instructing a human to stop a vehicle. In some embodiments, the system detects errors in an automated driving function. In some embodiments, the system determines that the system cannot control a vehicle under detected driving conditions.

In some embodiments, the technology is related to a safety system configured to perform a method for disaster evacuation. In some embodiments, the method comprises controlling vehicles in the evacuation area. In some embodiments, the method comprises increasing the priority of a vehicle in the evacuation area to the highest level. In some embodiments, an RSU and/or a network of RSU in the evacuation area is configured to control vehicles in the evacuation area and/or set the priority of a vehicle in the evacuation area to the highest level. In some embodiments, the method comprises controlling all travel modes in the evacuation area and/or increasing the priority of all vehicles in the evacuation area to the highest level.

In some embodiments, the technology is related to a safety system configured to perform a method for roadside object identification and behavior prediction. In some embodiments, the methods comprise identifying roadside objects. In some embodiments, identifying roadside objects comprises identifying the location, type, characteristics, and movement of the roadside object. In some embodiments, methods comprise recognizing behavior of the roadside object. In some embodiments, recognizing behavior of the roadside object comprises matching observed behavior to a behavior profile. In some embodiments, methods comprise predicting behavior of the roadside object. In some embodiments, predicting behavior of the roadside object comprises matching observed behavior to a behavior profile. In some embodiments, the roadside object is a non-motorized vehicle (e.g., a bicycle). In some embodiments, methods comprise identifying a roadside object waiting for a gap in traffic to cross a street, standing on a roadside, and/or moving along the sidewalk.

In some embodiments, the technology provides a safety technologies as described herein and a vehicle operations and control system comprising one or more of a roadside unit (RSU) network; a Traffic Control Unit (TCU) and Traffic Control Center (TCC) network (e.g., TCU/TCC network); a vehicle comprising an onboard unit (OBU); and/or a Traffic Operations Center (TOC).

In some embodiments, the technology provides a system (e.g., a vehicle operations and control system comprising a RSU network; a TCU/TCC network; a vehicle comprising an onboard unit OBU; a TOC; and a cloud-based platform configured to provide information and computing services; see, e.g., U.S. Provisional Patent Application Ser. No. 62/691,391, incorporated herein by reference in its entirety) configured to provide sensing functions, transportation behavior prediction and management functions, planning and decision making functions, and/or vehicle control functions. In some embodiments, the system comprises wired and/or wireless communications media. In some embodiments, the system comprises a power supply network. In some embodiments, the system comprises a cyber-safety and security system. In some embodiments, the system comprises a real-time communication function.

In some embodiments, the RSU network of embodiments of the systems provided herein comprises an RSU subsystem. In some embodiments, the RSU subsystem comprises: a sensing module configured to measure characteristics of the driving environment; a communication module configured to communicate with vehicles, TCUs, and the cloud; a data processing module configured to process, fuse, and compute data from the sensing and/or communication modules; an interface module configured to communicate between the data processing module and the communication module; and an adaptive power supply module configured to provide power and to adjust power according to the conditions of the local power grid. In some embodiments, the adaptive power supply module is configured to provide backup redundancy. In some embodiments, communication module communicates using wired or wireless media.

In some embodiments, sensing module comprises a radar based sensor. In some embodiments, sensing module comprises a vision based sensor. In some embodiments, sensing module comprises a radar based sensor and a vision based sensor and wherein said vision based sensor and said radar based sensor are configured to sense the driving environment and vehicle attribute data. In some embodiments, the radar based sensor is a LIDAR, microwave radar, ultrasonic radar, or millimeter radar. In some embodiments, the vision based sensor is a camera, infrared camera, or thermal camera. In some embodiments, the camera is a color camera.

In some embodiments, the sensing module comprises a satellite based navigation system. In some embodiments, the sensing module comprises an inertial navigation system. In some embodiments, the sensing module comprises a satellite based navigation system and an inertial navigation system and wherein said sensing module comprises a satellite based navigation system and said inertial navigation system are configured to provide vehicle location data. In some embodiments, the satellite based navigation system is a Differential Global Positioning Systems (DGPS) or a BeiDou Navigation Satellite System (BDS) System or a GLONASS Global Navigation Satellite System. In some embodiments, the inertial navigation system comprises an inertial reference unit.

In some embodiments, the sensing module of embodiments of the systems described herein comprises a vehicle identification device. In some embodiments, the vehicle identification device comprises RFID, Bluetooth, Wi-fi (IEEE 802.11), or a cellular network radio, e.g., a 4G or 5G cellular network radio.

In some embodiments, the RSU sub-system is deployed at a fixed location near road infrastructure. In some embodiments, the RSU sub-system is deployed near a highway roadside, a highway on ramp, a highway off ramp, an interchange, a bridge, a tunnel, a toll station, or on a drone over a critical location. In some embodiments, the RSU sub-system is deployed on a mobile component. In some embodiments, the RSU sub-system is deployed on a vehicle drone over a critical location, on an unmanned aerial vehicle (UAV), at a site of traffic congestion, at a site of a traffic accident, at a site of highway construction, at a site of extreme weather. In some embodiments, a RSU sub-system is positioned according to road geometry, heavy vehicle size, heavy vehicle dynamics, heavy vehicle density, and/or heavy vehicle blind zones. In some embodiments, the RSU sub-system is installed on a gantry (e.g., an overhead assembly, e.g., on which highway signs or signals are mounted). In some embodiments, the RSU sub-system is installed using a single cantilever or dual cantilever support.

In some embodiments, the TCC network of embodiments of the systems described herein is configured to provide traffic operation optimization, data processing and archiving. In some embodiments, the TCC network comprises a human operations interface. In some embodiments, the TCC network is a macroscopic TCC, a regional TCC, or a corridor TCC based on the geographical area covered by the TCC network. See, e.g., U.S. patent application Ser. No. 15/628,331, filed Jun. 20, 2017 and U.S. Provisional Patent Application Ser. Nos. 62/626,862, filed Feb. 6, 2018, 62/627,005, filed Feb. 6, 2018, 62/655,651, filed Apr. 10, 2018, and 62/669,215, filed May 9, 2018, each of which is incorporated herein in its entirety for all purposes.

In some embodiments, the TCU network is configured to provide real-time vehicle control and data processing. In some embodiments, the real-time vehicle control and data processing are automated based on preinstalled algorithms.

In some embodiments, the TCU network is a segment TCU or a point TCUs based on based on the geographical area covered by the TCU network. See, e.g., U.S. patent application Ser. No. 15/628,331, filed Jun. 20, 2017 and U.S. Provisional Patent Application Ser. Nos. 62/626,862, filed Feb. 6, 2018, 62/627,005, filed Feb. 6, 2018, 62/655,651, filed Apr. 10, 2018, and 62/669,215, filed May 9, 2018, each of which is incorporated herein in its entirety for all purposes. In some embodiments, the system comprises a point TCU physically combined or integrated with an RSU. In some embodiments, the system comprises a segment TCU physically combined or integrated with a RSU.

In some embodiments, the TCC network of embodiments of the systems described herein comprises macroscopic TCCs configured to process information from regional TCCs and provide control targets to regional TCCs; regional TCCs configured to process information from corridor TCCs and provide control targets to corridor TCCs; and corridor TCCs configured to process information from macroscopic and segment TCUs and provide control targets to segment TCUs. See, e.g., U.S. patent application Ser. No. 15/628,331, filed Jun. 20, 2017 and U.S. Provisional Patent Application Ser. Nos. 62/626,862, filed Feb. 6, 2018, 62/627,005, filed Feb. 6, 2018, 62/655,651, filed Apr. 10, 2018, and 62/669,215, filed May 9, 2018, each of which is incorporated herein in its entirety for all purposes.

In some embodiments, the TCU network comprises: segment TCUs configured to process information from corridor and/or point TOCs and provide control targets to point TCUs; and point TCUs configured to process information from the segment TCU and RSUs and provide vehicle-based control instructions to an RSU. See, e.g., U.S. patent application Ser. No. 15/628,331, filed Jun. 20, 2017 and U.S. Provisional Patent Application Ser. Nos. 62/626,862, filed Feb. 6, 2018, 62/627,005, filed Feb. 6, 2018, 62/655,651, filed Apr. 10, 2018, and 62/669,215, filed May 9, 2018, each of which is incorporated herein in its entirety for all purposes.

In some embodiments, the RSU network of embodiments of the systems provided herein provides vehicles with customized traffic information and control instructions and receives information provided by vehicles.

In some embodiments, the TCC network of embodiments of the systems provided herein comprises one or more TCCs comprising a connection and data exchange module configured to provide data connection and exchange between TCCs. In some embodiments, the connection and data exchange module comprises a software component providing data rectify, data format convert, firewall, encryption, and decryption methods. In some embodiments, the TCC network comprises one or more TCCs comprising a transmission and network module configured to provide communication methods for data exchange between TCCs. In some embodiments, the transmission and network module comprises a software component providing an access function and data conversion between different transmission networks within the cloud platform. In some embodiments, the TCC network comprises one or more TCCs comprising a service management module configured to provide data storage, data searching, data analysis, information security, privacy protection, and network management functions. In some embodiments, the TCC network comprises one or more TCCs comprising an application module configured to provide management and control of the TCC network. In some embodiments, the application module is configured to manage cooperative control of vehicles and roads, system monitoring, emergency services, and human and device interaction.

In some embodiments, TCU network of embodiments of the systems described herein comprises one or more TCUs comprising a sensor and control module configured to provide the sensing and control functions of an RSU. In some embodiments, the sensor and control module is configured to provide the sensing and control functions of radar, camera, RFID, and/or V2I (vehicle-to-infrastructure) equipment. In some embodiments, the sensor and control module comprises a DSRC, GPS, 4G, 5G, and/or wifi radio. In some embodiments, the TCU network comprises one or more TCUs comprising a transmission and network module configured to provide communication network function for data exchange between an automated heavy vehicles and a RSU. In some embodiments, the TCU network comprises one or more TCUs comprising a service management module configured to provide data storage, data searching, data analysis, information security, privacy protection, and network management. In some embodiments, the TCU network comprises one or more TCUs comprising an application module configured to provide management and control methods of an RSU. In some embodiments, the management and control methods of an RSU comprise local cooperative control of vehicles and roads, system monitoring, and emergency service. In some embodiments, the TCC network comprises one or more TCCs further comprising an application module and said service management module provides data analysis for the application module. In some embodiments, the TCU network comprises one or more TCUs further comprising an application module and said service management module provides data analysis for the application module.

In some embodiments, the TOC of embodiments of the systems described herein comprises interactive interfaces. In some embodiments, the interactive interfaces provide control of said TCC network and data exchange. In some embodiments, the interactive interfaces comprise information sharing interfaces and vehicle control interfaces. In some embodiments, the information sharing interfaces comprise: an interface that shares and obtains traffic data; an interface that shares and obtains traffic incidents; an interface that shares and obtains passenger demand patterns from shared mobility systems; an interface that dynamically adjusts prices according to instructions given by said vehicle operations and control system; and/or an interface that allows a special agency (e.g., a vehicle administrative office or police) to delete, change, and share information. In some embodiments, the vehicle control interfaces of embodiments of the interactive interfaces comprise: an interface that allows said vehicle operations and control system to assume control of vehicles; an interface that allows vehicles to form a platoon with other vehicles; and/or an interface that allows a special agency (e.g., a vehicle administrative office or police) to assume control of a vehicle. In some embodiments, the traffic data comprises vehicle density, vehicle velocity, and/or vehicle trajectory. In some embodiments, the traffic data is provided by the vehicle operations and control system and/or other share mobility systems. In some embodiments, traffic incidents comprise extreme conditions, major accident, and/or a natural disaster. In some embodiments, an interface allows the vehicle operations and control system to assume control of vehicles upon occurrence of a traffic event, extreme weather, or pavement breakdown when alerted by said vehicle operations and control system and/or other share mobility systems. In some embodiments, an interface allows vehicles to form a platoon with other vehicles when they are driving in the same dedicated and/or same non-dedicated lane.

In some embodiments, the OBU of embodiments of systems described herein comprises a communication module configured to communicate with an RSU. In some embodiments, the OBU comprises a communication module configured to communicate with another OBU. In some embodiments, the OBU comprises a data collection module configured to collect data from external vehicle sensors and internal vehicle sensors; and to monitor vehicle status and driver status. In some embodiments, the OBU comprises a vehicle control module configured to execute control instructions for driving tasks. In some embodiments, the driving tasks comprise car following and/or lane changing. In some embodiments, the control instructions are received from an RSU. In some embodiments, the OBU is configured to control a vehicle using data received from an RSU. In some embodiments, the data received from said RSU comprises: vehicle control instructions; travel route and traffic information; and/or services information. In some embodiments, the vehicle control instructions comprise a longitudinal acceleration rate, a lateral acceleration rate, and/or a vehicle orientation. In some embodiments, the travel route and traffic information comprise traffic conditions, incident location, intersection location, entrance location, and/or exit location. In some embodiments, the services data comprises the location of a fuel station and/or location of a point of interest. In some embodiments, OBU is configured to send data to an RSU. In some embodiments, the data sent to said RSU comprises: driver input data; driver condition data; vehicle condition data; and/or goods condition data. In some embodiments, the driver input data comprises origin of the trip, destination of the trip, expected travel time, service requests, and/or level of hazardous material. In some embodiments, the driver condition data comprises driver behaviors, fatigue level, and/or driver distractions. In some embodiments, the vehicle condition data comprises vehicle ID, vehicle type, and/or data collected by a data collection module. In some embodiments, the goods condition data comprises material type, material weight, material height, and/or material size.

In some embodiments, the OBU of embodiments of systems described herein is configured to collecting data comprising: vehicle engine status; vehicle speed; goods status; surrounding objects detected by vehicles; and/or driver conditions. In some embodiments, the OBU is configured to assume control of a vehicle. In some embodiments, the OBU is configured to assume control of a vehicle when the automated driving system fails. In some embodiments, the OBU is configured to assume control of a vehicle when the vehicle condition and/or traffic condition prevents the automated driving system from driving said vehicle. In some embodiments, the vehicle condition and/or traffic condition is adverse weather conditions, a traffic incident, a system failure, and/or a communication failure.

Also provided herein are methods employing any of the systems described herein for the management of one or more aspects of traffic control. The methods include those processes undertaken by individual participants in the system (e.g., drivers, public or private local, regional, or national transportation facilitators, government agencies, etc.) as well as collective activities of one or more participants working in coordination or independently from each other.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

In some embodiments, the technology relates to the use of a connected automated vehicle highway system and methods and/or components thereof for heavy and special vehicles, e.g., as described in U.S. Provisional Patent Application Ser. No. 62/687,435, filed Jun. 20, 2018, which is incorporated herein by reference.

Additional embodiments will be apparent to persons skilled in the relevant art based on the teachings contained herein.

### BRIEF DESCRIPTION OF THE DRAWINGS

The patent or application file contains at least one drawing executed in color. Copies of this patent or patent application publication with color drawings will be provided by the Office upon request and payment of the necessary fee.

These and other features, aspects, and advantages of the present technology will become better understood with regard to the following drawings:

FIG. 1 is a schematic drawing showing embodiments of RSU based Microscopic Safety Methods. Features of embodiments of the technology shown in FIG. 1 include, e.g., RSU—roadside unit 101; OBU—onboard unit 102; TCC/TCU—traffic control center/traffic control unit 103; control command (e.g., specific instructions for vehicle to operate) 104; and/or information (e.g., data needed for determining safety scenario and developing control strategy) 105.

FIG. 2 is a schematic drawing showing embodiments of Mesoscopic Safety Methods. Features of embodiments of the technology shown in FIG. 2 include, e.g., Mesoscopic Event 201; CAVH Cloud 202; Transportation Operation Center 203; Traffic Control Center 204; Traffic Control Unit 205; Roadside Unit 206; CAVH system-controlled Vehicle 207; CAVH Cloud detection or receipt of mesoscopic event 208; Data flow between CAVH Cloud and Vehicles 209; Data flow between CAVH Cloud and TOC 210; TOC detection or receipt of mesoscopic event 211; Data flow between RSU and Vehicles 212; Data flow between RSU and TCU 213; and/or RSUs detection or receipt of mesoscopic event 214.

FIGS. 3A and 3B are schematic drawings showing embodiments of Macroscopic Safety Methods.

FIG. 4 is a flowchart showing embodiments of Vehicle based Microscopic Safety Methods.

FIG. 5 is a schematic drawing showing embodiments of vehicle data hot backup. Features of embodiments of the technology shown in FIG. 5 include, e.g., backup data real time transfer from the vehicles on road to RSU 501; backup data gathered from the RSU transfer to the vehicle 502; backup data and other information gathered from the RSU transfer to the cloud 511; backup data gathered from the cloud transfer to the RSU in real time 512; backup data gathered from the Vehicle transfer to the cloud in real time 521; and/or backup data gathered from the cloud transfer to the vehicle in real time 522.

FIG. 6 is a flowchart showing embodiments of guided crash methods.

FIG. 7 is a flowchart showing embodiments of emergency braking methods.

FIG. 8 is a flowchart showing embodiments of platoon coordination methods.

FIGS. 9A and 9B is a schematic drawing and flowchart showing embodiments of systems and methods for providing pavement condition warnings.

FIG. 10 is a schematic drawing showing embodiments of systems and methods for incident management.

FIG. 11 is a schematic drawing showing embodiments of systems and methods for Pedestrian/bicycle detection and warning. Features of embodiments of the technology shown in FIG. 11 include, e.g., Pedestrian/bicycle is detected by RSU using sensing device 711; Pedestrian/bicycle is detected by vehicle using sensing device 712; Pedestrian/bicycle is detected by TCC/TCU using mobile data 713; Pedestrian/bicycle information is sent to TCC/TCU 721; RSU synchronizes Pedestrian/bicycle information from TCC/TCU 722; Vehicle sends Pedestrian/bicycle information to the RSU that controls the area 723; Vehicle sends Pedestrian/bicycle information to other vehicles in the area 724; and/or RSU controls vehicle to avoid pedestrian/bicycle 730.

FIG. 12 is a schematic drawing showing embodiments of systems and methods for dynamic routing for emergency vehicles. Features of embodiments of the technology shown in FIG. 12 include, e.g., TOC—traffic control center 1001; Relative RSU (e.g., a roadside unit within certain range of safety event) 1002; Emergency agency 1003; Emergency vehicle 1004; Command to clear path (e.g., command from TCC to relative RSUs to clear path to safety event for emergency vehicle) 1005; Emergency vehicle request 1006; Guidance command for emergency vehicle to proceed to safety event 1007.

FIG. 13 is a schematic drawing showing embodiments of systems and methods for managing communication failures.

FIG. 14 is a schematic drawing showing embodiments of systems and methods relating to a human driver assuming control of a vehicle.

FIG. 15 is a schematic drawing showing embodiments of systems and methods for disaster evacuation. Features of embodiments of the technology shown in FIG. 15 include, e.g. RSU at disaster area report disaster alert to TCU 511; RSU at disaster area increase priority level of OBU(s) to highest in controlled area 512; TCC/TCU identify nearest or suitable hospital/refuge/assembly station and distribute disaster alert (including location/severity/time) to RSU(s) that controls those area 521, 522, 523; and/or RSU controls the movement of vehicles according to their priority 531, 532, 533.

FIG. 16 is a schematic drawing showing embodiments of systems and methods for roadside object identification and vehicle warning. Features of embodiments of the technology shown in FIG. 16 include, e.g., RSU detecting pedestrian on the roadside 1601; TCC/TCU network and cloud 1602 configured to provide RSU with object identification and/or behavior prediction model parameters; RSU 1603 sending detected overall environment information to the TCC/TCU network and the cloud; and RSU 1604 sending warning messages (e.g., pedestrian characteristics, location, movement trace, and prediction) to vehicles in the proximity.

FIG. 17 is a schematic drawing showing embodiments of an active safety measure. Features of embodiments of the technology shown in FIG. 17 include, e.g., RSU 1701 detecting a vulnerable object (e.g., a pedestrian) on the roadside; TCC/TCU network and CAVH cloud 1702 providing RSU with object identification and behavior prediction model parameters; RSU 1703 sending environment information to the TCC/TCU network and the cloud; RSU 1704 sending warning messages to vehicles in the proximity; RSU 1705 detecting an impaired vehicle or uncontrolled vehicle; normally operating vehicles 1706; uncontrolled vehicle 1707; and RSU 1708 controlling roadside safety measures (e.g., deploying a roadside airbag to protect the vulnerable object).

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

In some embodiments, provided herein are technologies related to safety systems and methods for traffic operations and control systems for connected and automated vehicles and highways (e.g., a CAVH system (e.g., as described in U.S. patent application Ser. No. 15/628,331, filed Jun. 20, 2017 and U.S. Provisional Patent Application Ser. Nos. 62/626,862, filed Feb. 6, 2018, 62/627,005, filed Feb. 6, 2018, 62/655,651, filed Apr. 10, 2018, and 62/669,215, filed May 9, 2018, the disclosures of which are herein incorporated by reference in their entireties).

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “sensing-free” method does not comprise a sensing step, a “controller-free” system does not comprise a controller, etc.

### DESCRIPTION

In some embodiments, the safety system provides safety and emergency functions to a CAVH system comprising one or more CAVH subsystems: 1) a hierarchical traffic control network comprising one or more Traffic Control Centers (TCCs) and/or local traffic controller units (TCUs); 2) a RSU (Road Side Unit) network (e.g., comprising integrated functionalities of vehicle sensors and/or infrastructure-to-vehicle (I2V) communication to deliver control instructions); 3) an OBU (On-Board Unit) network (e.g., comprising sensor and/or vehicle-to-infrastructure (V2I) communication units) embedded in connected and automated vehicles; and 4) a wireless communication and security system with local and global connectivity. In some embodiments, the safety system provides proactive, reactive, and/or passive safety measures at macroscopic, mesoscopic, and microscopic levels for various travel modes (e.g., motorized and non-motorized vehicles and pedestrians). In some embodiments, the safety system is built on top of CAVH system functions, e.g., sensing, behavior prediction and management, planning and decision making, and control. In some embodiments, the technology relates to the use of a connected automated vehicle highway system and methods and/or components thereof for heavy and special vehicles, e.g., as described in U.S. Provisional Patent Application Ser. No. 62/687,435, filed Jun. 20, 2018, which is incorporated herein by reference.

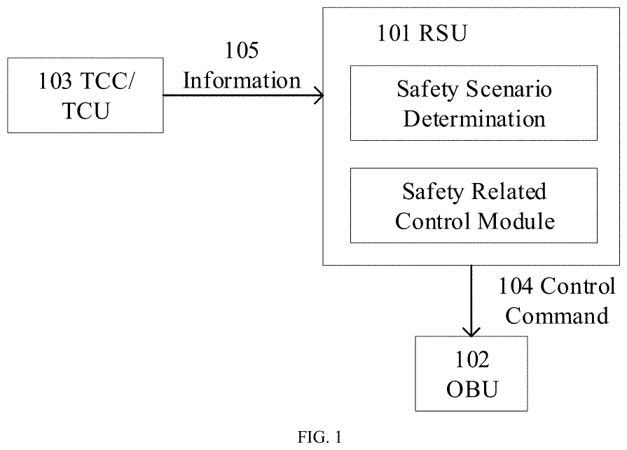

In some embodiments, e.g., as shown in FIG. 1, the technology comprises Microscopic Safety Methods (e.g., RSU-based Microscopic Safety Methods). In some embodiments, the Microscopic Safety Methods involve communication of a RSU 101, OBU 102, TCC/TCU 103, a control command component configured to provide specific instructions to a vehicle to control the operation of the vehicle, and information 105 comprising, e.g., data related to determining a safety scenario and developing a control strategy.

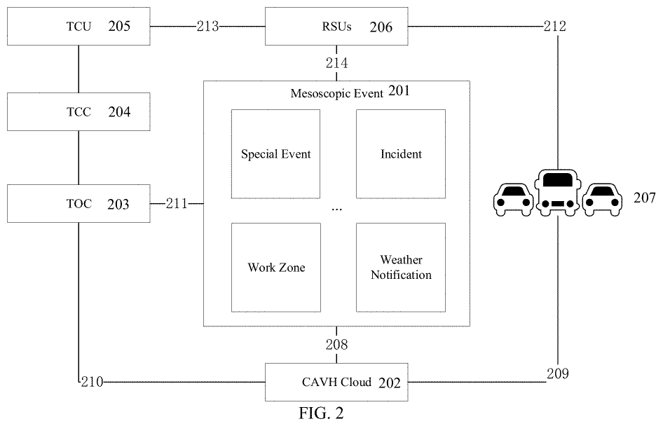

In some embodiments, as shown in FIG. 2, the technology comprises Mesoscopic Safety Methods. In some embodiments, the Mesoscopic Safety Methods involve one or more components configured to publish or detect a mesoscopic event 201. For example, embodiments of the technology related to Mesoscopic Safefy Methods comprise a CAVH Cloud 202 (see, e.g., U.S. Provisional Patent Application Ser. No. 62/691,391, incorporated herein by reference in its entirety), a TOC 203, and one or more RSU 206 (e.g., in a RSU network). In embodiments of methods and systems provided herein, when the CAVH Cloud detects or receives a mesoscopic event 208, the CAVH Cloud computes solutions and sends instructions 209 to vehicles 107. In some embodiments, e.g., when the CAVH cloud does not determine a solution, the CAVH cloud asks the TOC to determine a course of action, e.g., comprising assessing the situation 210. In some embodiments, when the TOC detects or receives events 211, the TOC determines a solution and send instructions through TCC 104, TCU 105, one or more RSU 206 (e.g., in a RSU network), and vehicles. In some embodiments, when RSU 206 detects events 211, the RSU attempts to compute a solution, e.g., when the RSU identifies a template solution (e.g., from a database comprising a plurality of template solutions matching event criteria). In some embodiments, the RSU identifies a template solution and sends control instructions to the vehicle 212. In some embodiments, the RSU does not identify a template solution and sends a query to an upper level unit 213 to asses situation and wait for solution instructions.

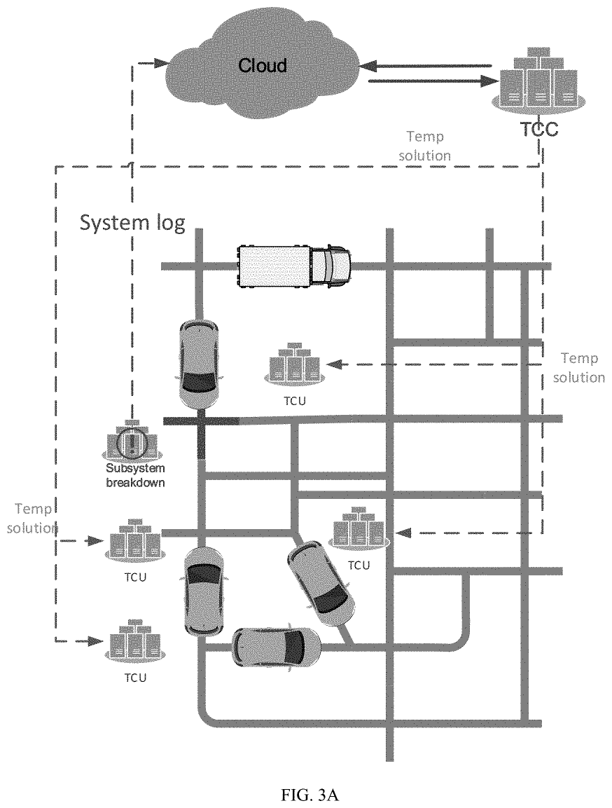

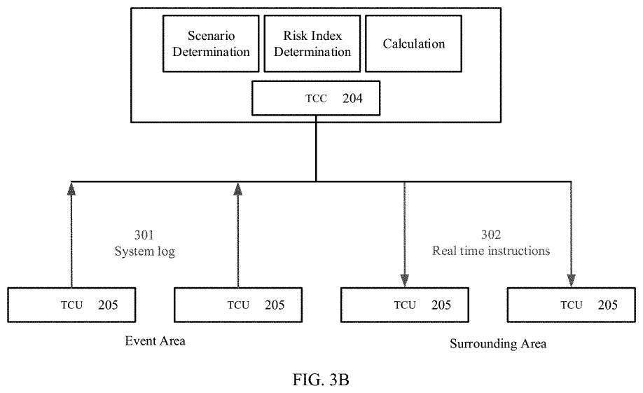

In some embodiments, e.g., as shown in FIG. 3A and FIG. 3B, the technology comprises Macroscopic Safety Methods. In some embodiments, the Macroscopic Safety Methods comprise systems are configured to address subsystem (e.g., TCU) breakdown (see, e.g., FIG. 3A and FIG. 3B). In some embodiments, subsystems upload logs to CAVH Cloud wirelessly. In some embodiments, subsystems upload logs to CAVH Cloud when errors are detected during operation (See, e.g., FIG. 3B, left arrows pointing up). In some embodiments, the CAVH cloud identifies and analyses a situation and sends error information to TCC. In some embodiments, the TCC produces a solution (e.g., to provide a fail-safe operation) and, in some embodiments, the the solution is distributed into subsystems (e.g., TCU). In some embodiments, upon instruction from an upper level system, a TCU sends commands to vehicles within range, e.g., minimizing, preventing, and/or eliminating unsafe consequences of the subsystem failure.

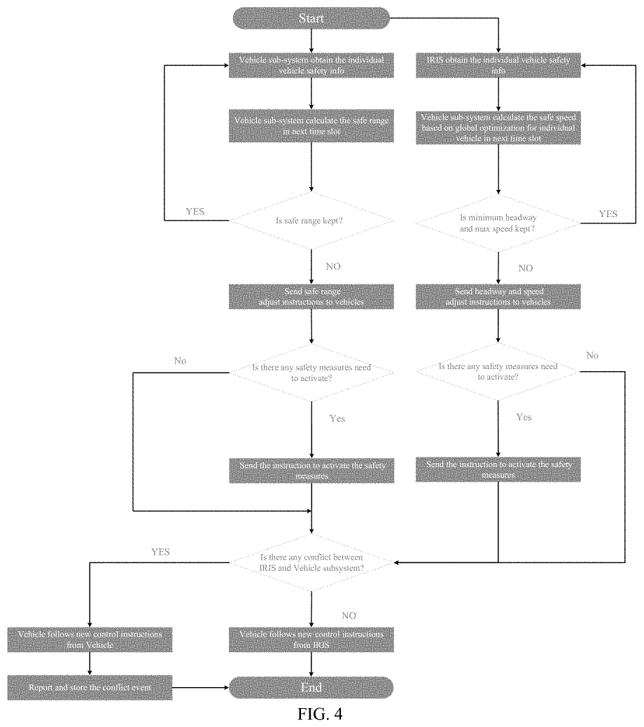

In some embodiments, e.g., as shown in FIG. 4, the technology comprises Vehicle based Microscopic Safety Methods. In some embodiments, Vehicle based Microscopic Safety Methods have a primary (e.g., dominant) role in providing safety, e.g., and the intelligent road infrastructure systems (IRIS) and/or sub-system have a secondary (e.g., supporting) role in providing safety. Accordingly, in some embodiments, (e.g., when Vehicle based Microscopic Safety Methods have a primary (e.g., dominant) role in providing safety and the intelligent road infrastructure systems (IRIS) and/or sub-system have a secondary (e.g., supporting) role in providing safety), a vehicle-subsystem provides a safety range (e.g., comprising local sensing and/or control decisions) to control the vehicle and the IRIS sub-system provides a control command based on a global perspective (e.g., comprising network and/or sub-system integration of sensing information and/or control decisions). In some embodiments, the system subsequently assesses the situation and determines if one or more safety measures need to be activated (e.g., comprising identifying a safety measure appropriate for the situation, activating the safety measure, and/or sending instructions and/or signals related to implementing the safety measure). In some embodiments, the instruction provided by the IRIS is required to meet the safety range determined by the Vehicle based Microscopic Safety Methods and/or safety range determined by a vehicle. Or, in some embodiments (e.g., when the Vehicle based Microscopic Safety Methods and/or vehicle have not determined a safety range and/or have determined an invalid safety range), the vehicle follows one or more instructions received from the vehicle sub-system. In some embodiments, conflicts in safety instructions (e.g., conflicts between the Vehicle based Microscopic Safety Methods and/or safety range determined by a vehicle and the IRIS sub-system) are stored and reported as events.

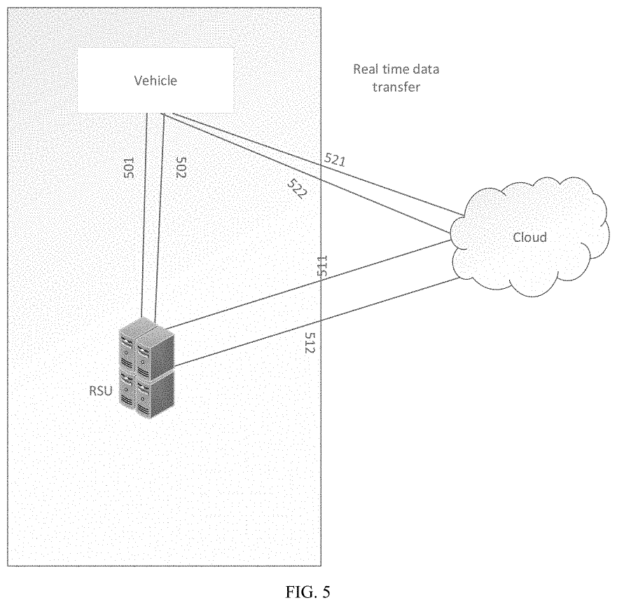

In some embodiments, e.g., as shown in FIG. 5, the technology comprises vehicle data hot backup. In some embodiments, vehicle data hot backup comprises a data flow, e.g., providing a real time hot backup system. For example, in some embodiments, vehicles send backup information to an RSU in real time. In some embodiments, the RSU provides backup information to the vehicle. In some embodiments, vehicles send backup information to an RSU in real time while the RSU provides backup information to the vehicle. In some embodiments, the RSU sends backup data to the CAVH cloud for backup. In some embodiments, the CAVH cloud sends backup data to the RSU for backup. In some embodiments, the cloud sends backup data directly to the vehicle. In some embodiments, a vehicle sends backup data to the CAVH cloud.

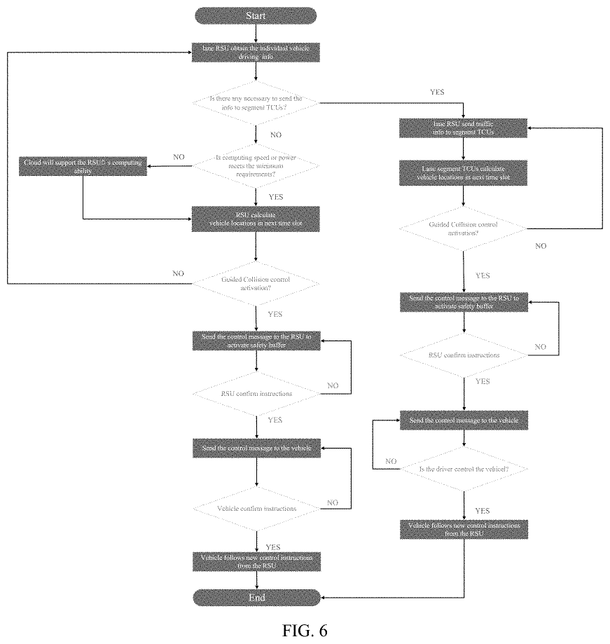

In some embodiments, e.g., as shown in FIG. 6, the technology comprises systems and methods for a guided crash, e.g., to guide vehicles into a controlled and guided crash. In some embodiments, vehicles are monitored by one or more RSU (e.g., by a network of RSU). In some embodiments, if related control thresholds are reached, guided crash control algorithms are triggered (e.g., in some embodiments the RSU activates a safety buffer). Then, in some embodiments, vehicles follow the new control instructions. In some embodiments, if instructions are not confirmed, new instructions are sent to the vehicles. In some embodiments, a situation receives attention by a TCU, e.g., in some embodiments, an RSU sends data to one or more TCU and/or an RSU follows instructions from a TCU.

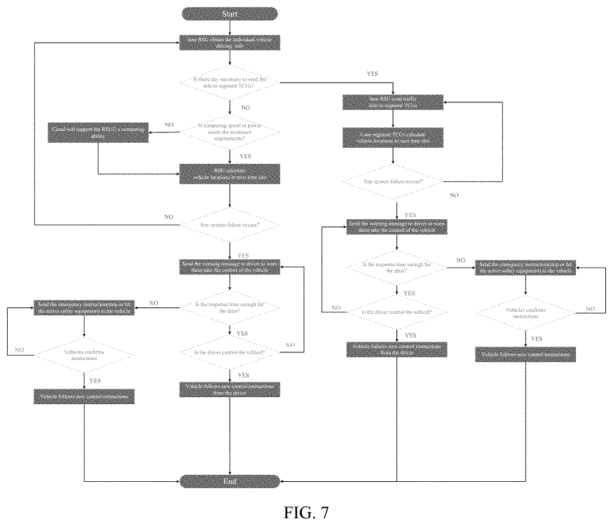

In some embodiments, e.g., as shown in FIG. 7, the technology comprises systems and methods for emergency braking. For example, in some embodiments, vehicles are monitored by one or more RSU (e.g., by a network of RSU). In some embodiments, if an error occurs, the system sends a warning message to a driver. In some embodiments, the message instructs the driver to assume control of the vehicle. In some embodiments in which the system determines that a driver should assume control of a vehicle and the driver does not subsequently assume control of the vehicle and/or the driver does not respond to a warning message and/or if the system determines that driver response time is not adequate for the driver to make a safe driving decision, the system assumes control of the vehicle and/or sends control thresholds to the vehicle. In some embodiments, if related control thresholds (e.g., stop the vehicle, hit the safety equipment, etc.) are reached, the necessary control algorithms are triggered. In some embodiments, vehicles follow the new control instructions. In some embodiments, if instructions are not confirmed, new instructions are sent to the vehicles. In some embodiments, a situation receives attention by a TCU, e.g., in some embodiments, an RSU sends data to one or more TCU and/or an RSU follows instructions from a TCU.

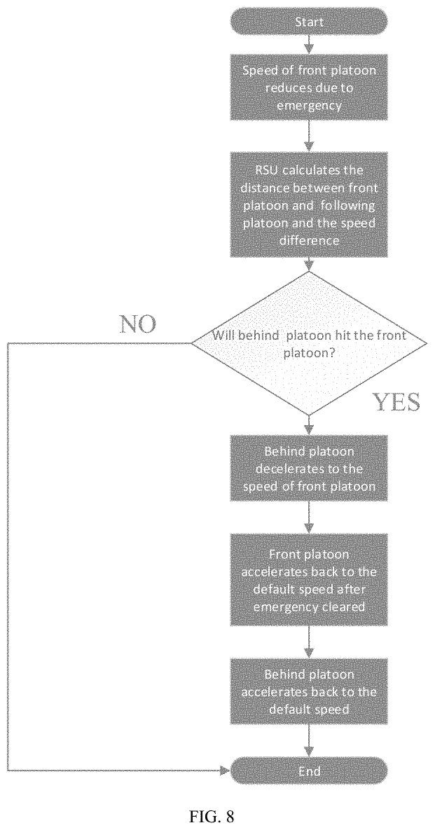

In some embodiments, e.g., as shown in FIG. 8, the technology comprises systems and methods for coordinating a platoon of vehicles (e.g., providing safety to a platoon of vehicles). For example, in some embodiments, vehicles are monitored by one or more RSU (e.g., by a network of RSU). In some embodiments, if an emergency occurs, the speed of a first, front car of a platoon is reduced. Accordingly, in some embodiments, the system determines if a second, following car will hit the first car at the current second-car speed before the first car accelerates. If no, the system does not send any instructions. If yes, the system reduces the speed of the second, following car to coordinate with the speed of the first, front car. In some embodiments, after the platoon is outside the emergency area, the platoon accelerates to the default (e.g., non-emergency) speed.

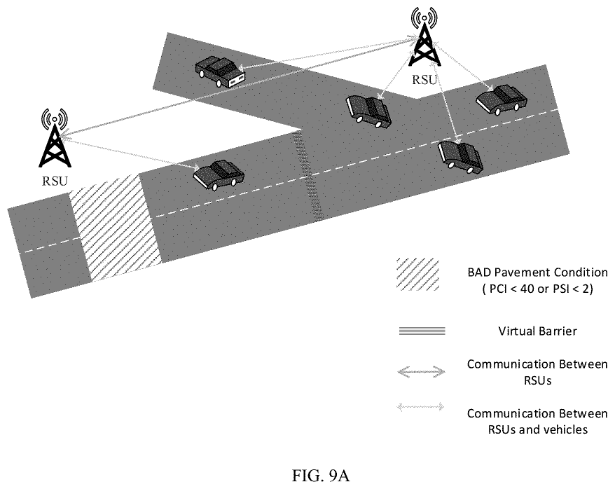

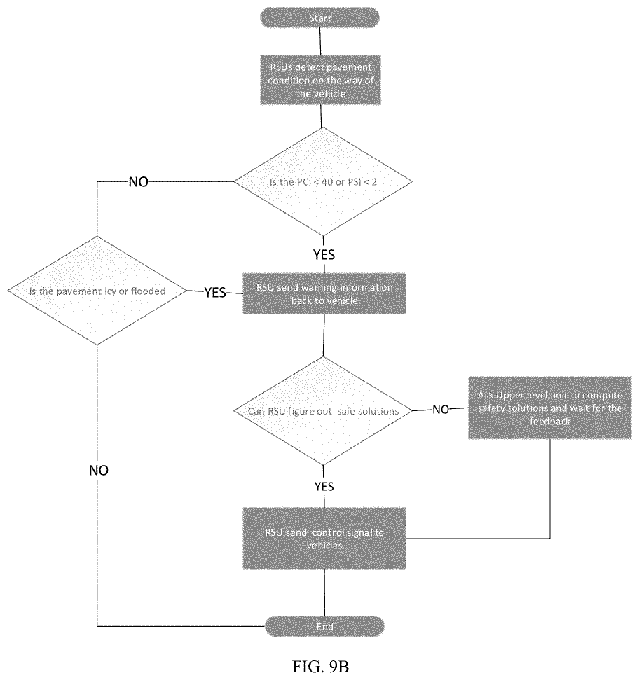

In some embodiments, e.g., as shown in FIG. 9A and FIG. 9B, the technology comprises systems and methods for providing a pavement condition warning, e.g., to assess the safety of a segment of pavement. In some embodiments, one or more RSU (e.g., a network of RSU) monitors and/or detects the pavement condition of a pavement segment that a vehicle is driving on, will be driving or, and/or is predicted to drive on. In some embodiments, the CAVH system (e.g., an RSU) determines and/or receives a pavement condition index characterizing the condition of the pavement. In some embodiments, the CAVH system (e.g., an RSU) determines and/or receives a serviceability index characterizing the access to a pavement segment and/or the ability of the pavement segment to be repaired. In some embodiments, if the pavement condition index is smaller than 40 and/or the serviceability index is smaller than 2, an RSU sends warning information to a vehicle and/or sends a control signal to a vehicle that controls the vehicle on the road segment according to a safe solution appropriate for safe driving on the pavement segment and for the pavement condition. In some embodiments, the system and/or RSU does not determine a solution and queries an upper level unit to analyze solutions and provide feedback to the RSU. In some embodiments, if the pavement is covered with ice, water, debris, or other material that compromises safety (e.g., decreases tire traction and/or hinders vehicle performance and/or control), the RSU proceeds through the steps above to determine an alternative plan or solutions for vehicles.

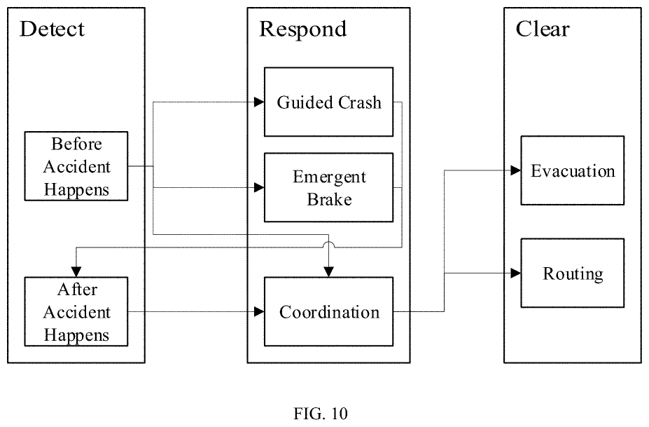

In some embodiments, e.g., as shown in FIG. 10, the technology comprises systems and methods for managing incidents. For example, in some embodiments, an RSU detects occurrence of an accident and constructs a response based on information associated with the occurrence of the accident (e.g., the RSU receives data and/or other information related to the accident (e.g., time of occurrence, video data, image data, sound data, vehicles involved, drivers, passengers, vehicle velocities, vehicle accelerations, etc.) In some embodiments, the incident management methods and systems determine if vehicles not involved in the accident should be controlled into a guided crash and/or if such vehicles should be slowed and/or stopped by emergency braking. In some embodiments, if an accident happens and coordination is needed, systems and methods for managing incidents contact necessary parties and/or entities (e.g., transportation operation agency, police department, and/or emergency agency, etc.) to direct and/or coordinate and/or execute evacuation and vehicle routing. In some embodiments, routing is used to assign appropriate routes to police vehicles or other emergency vehicles. In some embodiments, routing is used to assign appropriate routes to passenger vehicles (e.g., non-police and/or non-emergency vehicles).

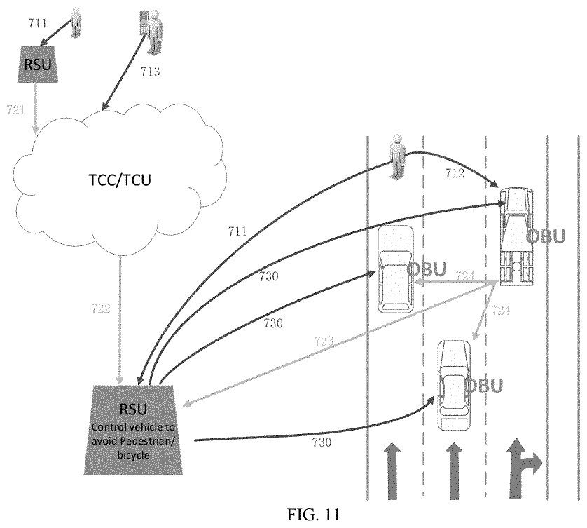

In some embodiments, e.g., as shown in FIG. 11, the technology comprises systems and methods for pedestrian/bicycle detection and warning. In some embodiments, an RSU controls a vehicle and/or platoon of vehicles in its controlled area to avoid a pedestrian/bicycle. In some embodiments, an RSU sends out an alerting sound or sends instructions to a vehicle to send out an alerting sound. In some embodiments, the systems and methods for pedestrian/bicycle detection and warning receive information comprising the position of a pedestrian/bicycle on a map. Various embodiments comprises data collection characterizing pedestrian/bicycle information. In some embodiments, pedestrian/bicycle information collected by RSU. In some embodiments, pedestrians/bicycles are detected by one or more vehicles in a controlled area and a message is broadcast to other vehicles and RSU and then a message is broadcast to TCC/TCU. In some embodiments, pedestrians/bicycles are detected by RSU and a message is uploaded to TCC/TCU. In some embodiments, pedestrians/bicycles are detected by a signal from a mobile terminal and a message is broadcast to related RSU.

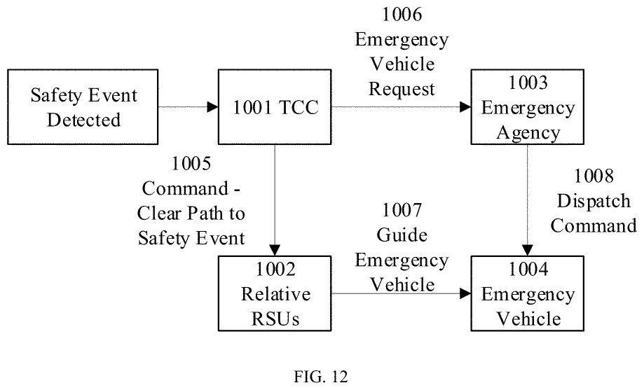

In some embodiments, e.g., as shown in FIG. 12, the technology comprises systems and methods for dynamic routing for emergency vehicles. For instance, in some embodiments, if a safety event is detected, TOC 1001 sends a command 1005 to one or more RSU 1002 to clear a path to the accident. In some embodiments, the TOC 1001 also sends an emergency vehicle request 1006 to an agency 1003, e.g., to request dispatch of an emergency vehicle. In some embodiments, the emergency vehicle travels on a route comprising the path cleared to the accident. In some embodiments, emergency agency 1003 sends a dispatch command 1008 to emergency vehicle 1004 and one or more RSU (e.g., a network of RSU) 1002 sends guidance information 1007 to emergency vehicle 1004.

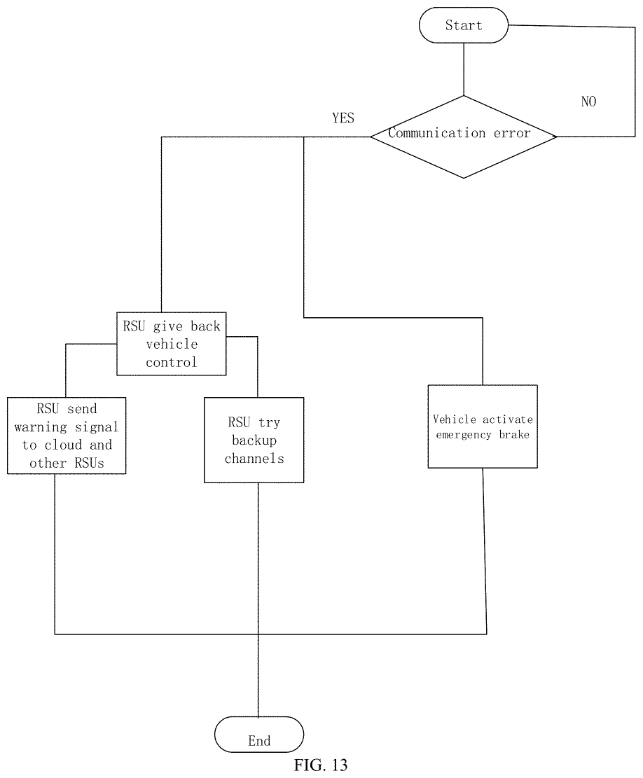

In some embodiments, e.g., as shown in FIG. 13, the technology comprises a component configured to respond to a communication failure. For example, in some embodiments, the system detects a communication error and an RSU transfers vehicle control from the system to the vehicle. In some embodiments, the vehicle activates an emergency stop program that safely (e.g., slowly) guides the vehicle to stop (e.g., at the side of the road, at a nearby sidewalk, in an emergency stop lane, etc.) In some embodiments, an RSU sends a warning signal to the CAVH cloud and/or other RSU. In some embodiments, the system attempts to send signals and/or instructions using backup communication channels to re-connect with the vehicle.

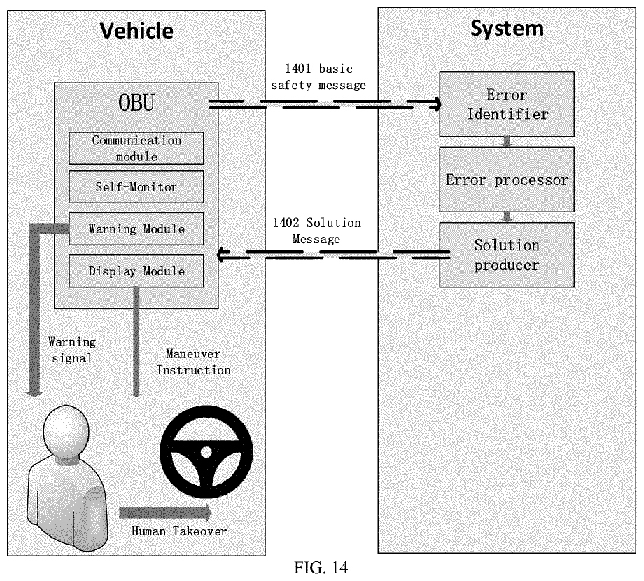

In some embodiments, e.g., as shown in FIG. 14, the technology comprises systems and methods to provide and/or manage for a human driver to assume control of a vehicle. For example, in some embodiments, a basic safety message 1401 is transferred between the system and a vehicle. In some embodiments, a basic safety message comprises, e.g., vehicle maneuver data, vehicle sensing data, driver data, and passenger data. In some embodiments, a solution message 1402 is transferred between the system and a vehicle. In some embodiments, a solution message comprises instructions for a vehicle to perform a maneuver, e.g., according to data gathered and assessment of the situation by the system and/or a component and/or subsystem of the system. In some embodiments, the technology comprises systems and methods for autopilot control of a vehicle. In some embodiments, when the autopilot feature of the system fails, the system comprises systems and methods to provide a human driver to assume vehicle control and thus improve safety. In some embodiments, when an error is detected, the system sends a signal to vehicles that are under control of the CAVH system. In some embodiments, a short interval (e.g., 1-10 seconds) of transition time is provided to wait for a human driver to react and assume control of a vehicle after the signal is provided to the vehicle and driver. In some embodiments, the systems and methods to provide and/or manage for a human driver to assume control of a vehicle provide a Maneuver Instruction to a driver of a vehicle. For example, after assuming vehicle control, instruction information characterizing operation (e.g., driving) of vehicles are produced and sent to human drivers to ensure the overall operation stability of the system.

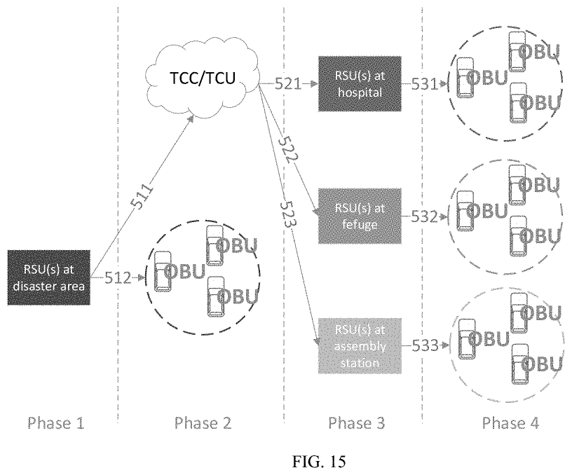

In some embodiments, e.g., as shown in FIG. 15, the technology comprises systems and methods for disaster evacuation. In some embodiments, systems and methods for disaster evacuation comprise one or more of, e.g. at RSU at a disaster area that prepares and sends a disaster alert 511 to TCU. In some embodiments, a RSU 512 at the disaster area increases a priority level of an OBU(s) to the highest priority in the area controlled by the RSU and/or other component of the system. In some embodiments, a TCC/TCU 521-523 receives information comprising the nearest and/or suitable hospital, refuge, shelter, and/or assembly station and distributes a disaster alert (e.g., comprising location, severity, and/or time) to RSU(s) that control the area. In some embodiments, a RSU 531-533 controls the movement of vehicles according to their priority. In some embodiments, RSU(s) at a disaster area detect the disaster and report a disaster alert to a TCU. In some embodiments, the priorities of all vehicles in the controlled area are increased to the highest level when the disaster alert is sent (e.g., coincident or essentially coincident or shortly before or after the disaster alert is sent). In some embodiments, the TCC/TCU identifies the nearest or suitable hospital, refuge, shelter, and/or assembly station and distributes a disaster alert (including location, severity, and/or time) to RSU(s) that control the area to minimize the transit time of highest priority level vehicles to a refuge, shelter, and/or assembly station.

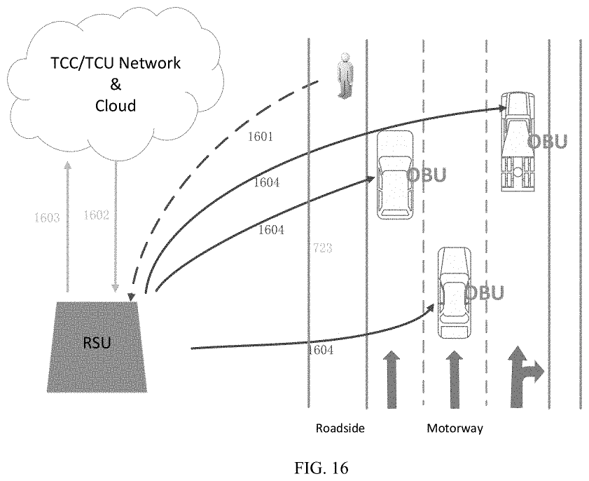

In some embodiments, e.g., as shown in FIG. 16, the technology comprises an RSU that senses the surrounding environment. In some embodiments, the RSU senses the environment to establish background signal levels. In some embodiments, the RSU is configured to update background signal levels. In some embodiments, the RSU is supported by a TCC/TCU and/or the cloud. In some embodiments, the TCC/TCU and/or the cloud receives and/or analyzes data (e.g., real-time, historical, cumulative, interpolated, estimated data) from an RSU, e.g., to train object identification and behavior prediction models. In some embodiments, the RSU identifies an object and said RSU uses calibrated parameters to determine the object type, location, characteristics, and/or further behavior (e.g., predicted behavior). In some embodiments, the RSU tracks the object until the object moves out of the detection range of the RSU. In some embodiments, the object is considered a risk and warning messages are sent to vehicles in the affected area. In some embodiments, information and data that are recorded provide inputs to a training model for object identification and behavior prediction, e.g., to predict future behavior.

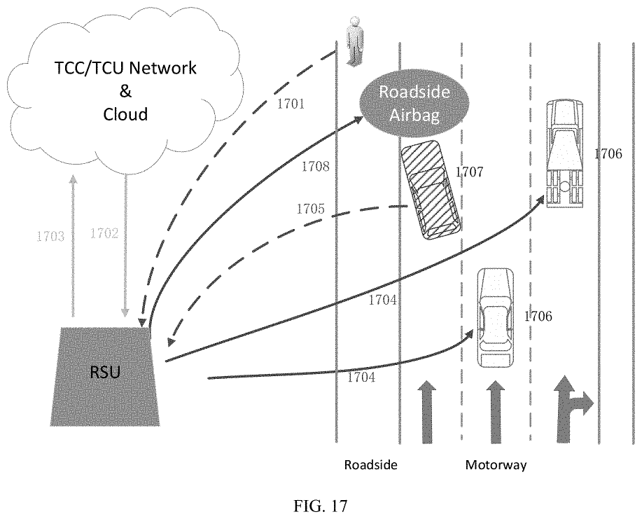

In some embodiments, e.g., as shown in FIG. 17, the technology comprises methods and systems configured to provide an active safety measure. In some embodiments, an RSU senses the surrounding environment. In some embodiments, the RSU senses the environment to establish background signal levels. In some embodiments, the RSU is configured to update background signal levels. In some embodiments, the RSU is supported by a TCC/TCU and/or the cloud. In some embodiments, the TCC/TCU and/or the cloud receives and/or analyzes data (e.g., real-time, historical, cumulative, interpolated, estimated data) from an RSU, e.g., to train object identification and behavior prediction models. In some embodiments, an RSU identifies an imminent risk (e.g., an uncontrolled vehicle (e.g., a vehicle that is predicted to crash into a sidewalk)) and the RSU sends commands to deploy a roadside safety device (e.g., a roadside airbag). In some embodiments, the roadside safety device protects the vulnerable object (e.g., a pedestrian, the crashing vehicle, and/or occupants of the crashing vehicle). In some embodiments, messages (e.g., warning messages) are sent to vehicles in the affected area. In some embodiments, information and data that are recorded provide inputs to a training model for object identification and behavior prediction, e.g., to predict future behavior.

1-153. (canceled)

154. A safety system for improving and/or providing safety operations and control for a connected and automated vehicle highway (CAVH) system, said CAVH system comprising one or more of:
a) a roadside unit (RSU) network;
b) a traffic control unit (TCU) and traffic control center (TCC) network;
c) one or more vehicle onboard units (OBU) and vehicle interfaces;
d) a traffic operations center (TOC); and/or
e) a cloud-based platform of information and computing services,
wherein said safety system is configured to provide detailed customized information and time-sensitive control instructions to individual transportation entities.

155. The safety system of claim 154 wherein said individual transportation entities comprise motorized vehicles, non-motorized vehicles, and pedestrians.

156. The safety system of claim 154 configured to perform:
a) proactive methods comprising predicting traffic incidents, estimating risk, and managing vehicles to minimize and/or eliminate a future chance of traffic incidents;
b) active methods comprising detecting traffic incidents and managing vehicles to minimize and/or eliminate a future chance of harm; and/or
c) passive methods comprising detecting traffic incidents and minimizing harms and losses.

157. The safety system of claim 154 configured to perform system tasks comprising sensing, predicting transportation behavior, planning and making decisions, controlling a vehicle, and/or deploying a safety device.

158. The safety system of claim 157 wherein:
a) an RSU, an individual vehicle, or a group of vehicles is/are configured to perform said system tasks;
b) one or more RSUs and one or more TCUs and/or TCCs is/are configured to perform said system tasks; and/or
c) said CAVH system configured to perform said system tasks.

159. The safety system of claim 158 configured to perform a method comprising:
a) predicting and/or identifying a safety issue;
b) generating a safety strategy to prevent and/or minimize harm from said safety issue;
c) sending control instructions from an RSU to an OBU to implement said safety strategy;
d) controlling a vehicle by an OBU according to said control instructions; and
e) receiving vehicle information, vehicle status, and safety requests by an RSU from an OBU.

160. The safety system of claim 154 further comprising physical safety measures, logical safety measures, and/or comprehensive safety measures.

161. The safety system of claim 160 wherein said physical safety measures comprise a roadside airbag module.

162. The safety system of claim 160 wherein said logical safety measures comprise incident management assistance methods comprising:
a) identifying an incident;
b) locating said incident, and
c) reporting said incident to first responders.

163. The safety system of claim 154 configured to perform methods for a guided crash, said methods comprising;
a) monitoring vehicles by an RSU;
b) identifying a crashing vehicle as a vehicle exceeding a control threshold;
c) triggering a physical safety measure for said crashing vehicle;
d) sending updated control instructions to said crashing vehicle; and/or
e) communicating warnings and/or updating control instructions to other vehicles.

164. The safety system of claim 154 configured to perform methods for emergency braking, said methods comprising:
a) monitoring vehicles by an RSU;
b) identifying an unsafe vehicle as a vehicle exceeding a control threshold;
c) sending a warning to said unsafe vehicle and requesting a driver of said unsafe vehicle to assume control of said unsafe vehicle; or sending control instructions to said unsafe vehicle; and/or
d) communicating warnings and/or updating control instructions to other vehicles.

165. The safety system of claim 154 configured to perform methods for platoon coordination comprising, said methods comprising:
a) adjusting the speed of the platoon-leading vehicle; and
b) calculating the speed adjustment for following vehicles to minimize traffic flow disturbance.

166. The safety system of claim 154 configured to perform methods for pavement condition warnings, said methods comprising:
a) detecting pavement conditions; and
b) providing customized information characterizing pavement conditions to vehicles.

167. The safety system of claim 154 configured to perform methods for incident management, said methods comprising:
a) detecting an incident; and
b) communicating information describing said incident to an incident management agency.

168. The safety system of claim 154 configured to perform methods for pedestrian and/or bicycle detecting and warning, said methods comprising:
a) detecting pedestrians and bicycles;
b) sending updated control instructions to vehicles to avoid pedestrians and/or bicycles; and/or
c) updating a map with the locations of pedestrians and/or bicycles.

169. The safety system of claim 154 configured to perform a method for dynamic routing of emergency vehicles, said method comprising:
a) communicating emergency vehicle requests to emergency agencies; and
b) sending control instructions to vehicles to clear a path for an emergency vehicle.

170. The safety system of claim 154 configured to perform a method for communication failure, said method comprising:
a) detecting a communication error;
b) transferring control of a vehicle from the CAVH system to said vehicle;
c) guiding said vehicle to a safe stop;
d) sending warnings to the cloud and/or one or more RSUs; and
e) re-connecting with said vehicles over a backup communication channel.

171. The safety system of claim 154 configured to perform a method for human control of a vehicle, said method comprising:
a) detecting failure or error of the CAVH system control of a vehicle or that the CAVH system is unable to control a vehicle;
b) sending a message to said vehicle controlled by the CAVH system that control will be transferred to a driver of said vehicle; and
c) transferring control of said vehicle to said driver.

172. The safety system of claim 154 configured to perform a method for disaster evacuation, said method comprising:
a) increasing the priorities of all vehicles in a disaster evacuation area to the highest level;
b) providing CAVH system control of all travel in the disaster evacuation area; and
c) guiding residents in the disaster evacuation area to evacuate the disaster evacuation area.

173. The safety system of claim 154 configured to provide data backups, wherein:
a) RSUs provide a first backup layer for vehicles and said RSUs communicate backed-up data to vehicles in real-time;
b) the cloud provides a second backup layer for vehicles; and
c) the cloud provides backup services for RSUs, TCCs, TCUs, and the TOC.

174. A method for providing safety control and operations for a CAVH system, said method comprising providing a safety system according to claim 154.
